(19) United States
(12) Patent Application Publication
(10) Pub. No.: US 2006/0251431 A1
(43) Pub. Date: Nov. 9, 2006

(54) Method and apparatus for optimizing print conditions in image forming apparatus

(75) Inventor: Kang-woo Lee, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/313,731

(22) Filed: Dec. 22, 2005

(30) Foreign Application Priority Data
May 9, 2005 (KR) 10-2005-0038381

(51) Int. Cl. G03G 15/00

(52) U.S. Cl. 399/16

(57) ABSTRACT

An apparatus and method for optimizing image forming conditions of an image forming apparatus by obtaining information regarding printing paper using radio frequency identification (RFID) technology and allowing the image forming conditions to be automatically optimized according to the obtained information. The method includes sensing whether a paper feeder is open, reading identification information of paper from an RFID tag when the paper feeder is open RFID; and determining optimal image forming conditions according to the read identification information.

### CROSS-REFERENCE TO RELATED PATENT APPLICATIONS

This application claims the benefit under 35 U.S.C. §119(a) of Korean Patent Application No. 10-2005-0038381, filed on May 9, 2005, in the Korean Intellectual Property Office, the entire disclosure of which is hereby incorporated by reference.

### BACKGROUND OF THE INVENTION

1. Field of the Invention

The present invention relates to an image forming apparatus and a method of controlling the same. More particularly, the present invention relates to an apparatus and method for optimizing image forming conditions of an image forming apparatus by acquiring printing paper information using radio frequency identification (RFID) technology and allowing the image forming conditions to be automatically optimized according to the printing paper information.

2. Description of the Related Art

The present invention is related to U.S. Pat. No. 6,712,446 and Korean Patent Publication No. 2002-04285, the entire disclosures of which are hereby incorporated by reference.

In general, an image forming apparatus is an office machine, such as a printer and a facsimile, which is connected to a computer to print the results of data processing on paper. The image forming apparatus receives a document or image data, as print data, which is created or edited using a computer, transforms it into a print language according to predetermined printing conditions, and prints the print language on paper using a dye such as ink or toner.

The size of printing paper is typically standardized, such as A4, legal, letter, B4, and A3, but the resistance characteristics, thickness, and fixation characteristics of printing paper differ according to manufacturing companies. The quality of an image is determined by the resistance characteristics, thickness, and fixation characteristics of printing paper.

Conventionally, image forming conditions, such as a transfer voltage, the speed of conveyance, and fixing temperature, are determined when designing an image forming apparatus, based on the averages of the resistance characteristic values, thicknesses, and fixation characteristic values of printing paper manufactured by major manufacturing companies. Accordingly, it is impossible to determine optimum image forming conditions that can cover the characteristics of various types of paper available to an image forming apparatus.

In addition, it is inconvenient for an ordinary user to determine the size of printing paper (A4, legal, letter, and so on), and to use a conventional image forming apparatus since the user must manually select the size of printing paper for each print job. To solve these problems, image forming apparatuses with sensors capable of automatically sensing the size of printing paper have been developed. However, further installation of sensors increases manufacturing costs and complicates the construction of an image forming apparatus.

### SUMMARY OF THE INVENTION

Embodiments of the present invention provide a method and apparatus for optimizing printing conditions of an image forming apparatus by detecting the characteristics of printing paper using radio frequency identification (RFID) technology and determining the optimum image forming conditions according to the detected characteristics.

According to an aspect of the present invention, a method of determining printing conditions of an image forming apparatus includes sensing whether a paper feeder is open, reading paper identification information from a radio frequency identification tag when the paper feeder is open, and determining optimal image forming conditions based on the read identification information.

According to another aspect of the present invention, an apparatus for determining printing conditions of an image forming apparatus comprises a radio frequency identification reader for reading information from a radio frequency identification tag. A paper feeder opening/closing detection sensor senses whether a paper feeder is open or closed. A controller enables the radio frequency identification reader only upon a receipt of status information indicating that the paper feeder is open from the paper feeder opening/closing detection sensor, parsing paper identification information read by the radio frequency identification reader, and determining optimal image forming conditions.

### BRIEF DESCRIPTION OF THE DRAWINGS

The above and other aspects and advantages of embodiments of the present invention will become more apparent from the following detailed description with reference to the attached drawings in which:

FIG. 1 is a block diagram of an apparatus for optimizing printing conditions of an image forming apparatus according to an embodiment of the present invention;

FIG. 2 is a detailed block diagram illustrating a radio frequency identification (RFID) reader and an RFID tag, illustrated in FIG. 1; and

FIG. 3 is a flowchart illustrating a method of optimizing printing conditions of an image forming apparatus according to an embodiment of the present invention.

Throughout the drawings, like reference numbers will be understood to refer to like elements, features and structures.

### DETAILED DESCRIPTION OF EXEMPLARY EMBODIMENTS

For convenience, a printer will be described as an exemplary embodiments of an image forming apparatus according to an embodiment of the present invention. However, it should be understood that the image forming apparatus is not limited to a printer. For instance, the image forming apparatus may be a facsimile or a copier, or any other suitable device.

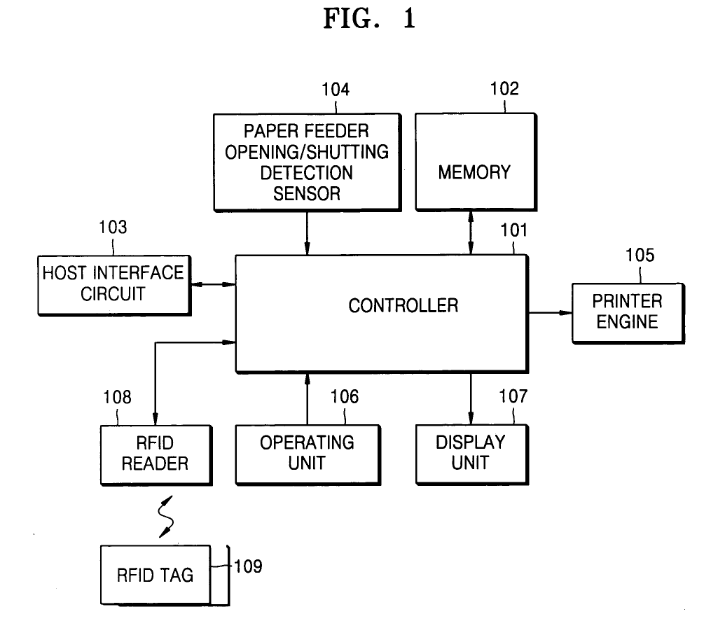

Referring to FIG. 1, an apparatus, such as a printer, which optimizes printing conditions of an image forming apparatus according to an embodiment of the present invention includes a controller 101, a memory 102 that stores a control program and data for controlling the printer, a host interface circuit 103, a paper feeder opening/closing detection sensor 104, such as a switch sensor, a print engine 105, an operating unit 106 that includes a panel with various operating keys of the printer, a display unit 107 that displays the status of the printer on a small screen, a radio frequency identification (RFID) reader 108, and a RFID tag 109.

In the radio frequency identification (RFID) technology used in embodiments of the present invention, information regarding an article is stored in a tag, which is preferably a chip attached to the article that acts as a transponder, and reads from the tag via an antenna using an RFID reader so as to perform a specific operation in a system.

RFID tags are categorized into active tags with a built-in battery, and passive tags that acquire energy from a signal emitted from the RFID reader without a battery. The apparatus according to an exemplary embodiment of the present invention uses the passive tag but it may also be designed to use the active tag.

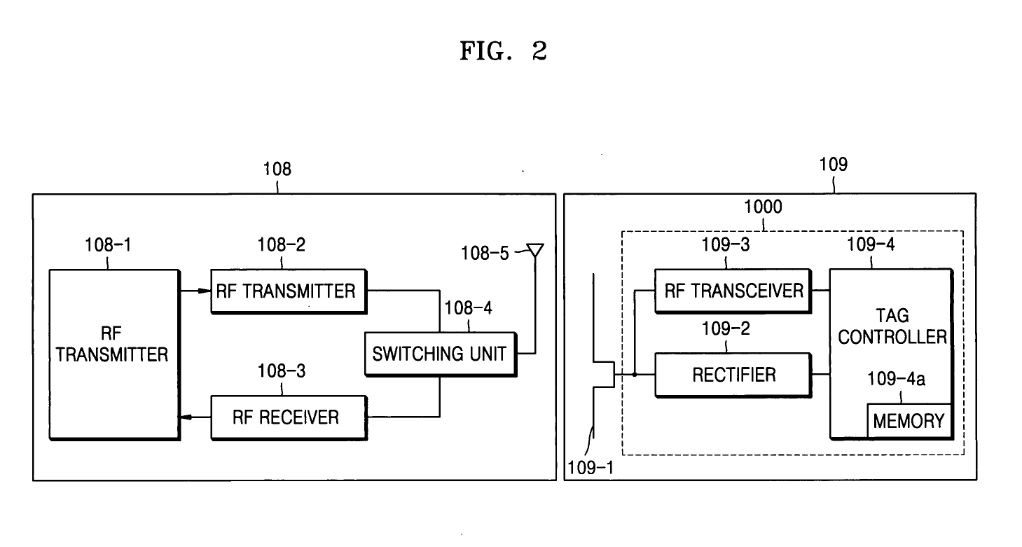

Referring to FIG. 2, the RFID reader 108 includes a reader controller 108-1, an RF transmitter 108-2, an RF receiver 108-3, a switching unit 108-4, and an antenna 108-5. The RFID tag 109 includes an antenna coil 109-1, a rectifier 109-2, an RF transceiver 109-3, and a tag controller 109-4 with a built-in memory 109-4a.

The memory 109-4a in the tag controller 109-4 stores paper identification information regarding the size, thickness, and type of paper. The paper identification information may further include the name of the manufacturing company and manufacture date of the paper.

The rectifier 109-2, the RF transceiver 109-3, and the tag controller 109-4 constituting the RFID tag 109 are preferably installed in a semiconductor integrated circuit 1000.

According to an exemplary embodiment, the RFID tag 109 is preferably attached to packing paper of printing paper or a box containing plural bundles of printing paper. The RFID reader 108 is preferably installed outside the printer, such as, on the panel of the operating unit 106.

The general operation of the printer according to an exemplary embodiment of the present invention will now be described. The printer receives source data from a computer (not shown) via the host interface circuit 103 and transmits it to the controller 101. The source data contains a stream of commands written in a language that the printer can recognize, and data representation of an image.

The controller 101 preferably extracts only the data representation of the image from the source data, processes it into image data preferably with four colors such as cyan (C), magenta (M), yellow (Y), and black (K), which meet a standard to be printed by the printer, and outputs the image data to the printer engine 105.

A process of acquiring information regarding the characteristics of printing paper and optimizing printing conditions using the RFID technology will now be described in greater detail.

The controller 101 monitors whether status information indicating whether a paper feeder (not shown) is open is received from the paper feeder opening/closing detection sensor 104.

The paper feeder opening/closing detection sensor 104, which senses whether the paper feeder is open or closed, generates the status information when the paper feeder is open and outputs it to the controller 101.

Upon receipt of the status information, the controller 101 generates an enable control signal to operate the RFID reader 108. The RFID reader 108 operates in response to the enable control signal.

The operations of the RFID reader 108 and the RFID tag 109 will now be described in detail with reference to FIG. 2. When the controller 101 transmits the enable control signal to the reader controller 108-1, the reader controller 108-1 generates a control signal to transmit a tag information requesting signal. Then, in response to the control signal received from the reader controller 108-1, the RF transmitter 108-2 generates a modulated tag information requesting signal of a particular frequency band and outputs it to the switching unit 108-4. The tag information requesting signal output from the switching unit 108-4 is emitted via the antenna 108-5. In this embodiment, the particular frequency band ranges from 4 to 20 MHz, but may be wider or narrower than the range from 4 to 20 MHz, if necessary.

While the coil antenna 109-1 of the RFID receives the tag information requesting signal emitted from the RFID reader 108, the received signal causes an induced electromotive force to be generated by the coil antenna 109-1. The rectifier 109-2A rectifies voltage, which is caused by the induced electromotive force, to be used as power to the RFID tag 109.

The tag information requesting signal emitted from the RFID reader 108 is received via the coil antenna 109-1 of the RFID tag 109, demodulated by the RF transceiver 109-3, and input to the tag controller 109-4. Then, the tag controller 109-4 reads tag information from the memory 109-4a in response to the demodulated tag information requesting signal. As described above, the tag information stored in the memory 109-4a according to an embodiment of the present invention is paper identification information specifying the size, thickness, and type of the paper.

The paper identification information read from the memory 109-4a is modulated by the RF transceiver 109-3 and emitted via the antenna coil 109-1.

The signal emitted from the RFID tag 109 is received via the antenna 108-5 of the RFID reader 108, sequentially input to the switching unit 108-4 and the RF receiver 109-3, modulated by the RF receiver 109-3, and then input to the reader controller 108-1.

Then, the reader controller 108-l transmits the demodulated identification information to the controller 101 of the printer.

As described above, the paper identification information is read from the RFID tag 109, which is preferably attached to packing paper of printing paper or a box containing plural bundles of printing paper, for example, via the RFID reader 108 installed in the printer without contacting the RFID tag 109, and the read information is transmitted to the controller 101.

The controller 101 parses the paper identification information received from the RFID reader 108 and optimizes printing conditions (or image forming conditions). Here, printing condition factors include a transfer voltage, fixing temperature, and the speed of reaction.

That is, the controller 101 optimizes the printing conditions, such as the transfer voltage, fixing temperature, and the speed of reaction, according to the size, thickness, and type of the printing paper which are specified in the paper identification information. Specifically, the optimum printing conditions may be determined according to characterization factors of the paper, specified in the paper identification information, using a lookup table. The lookup table is preferably obtained by experimentally measuring printing factors for optimizing the quality of printing from the factors specified in the identification information when designing an image forming apparatus.

The optimized printing conditions determined by the controller 101 are applied to the printer engine 105 to perform a printing process.

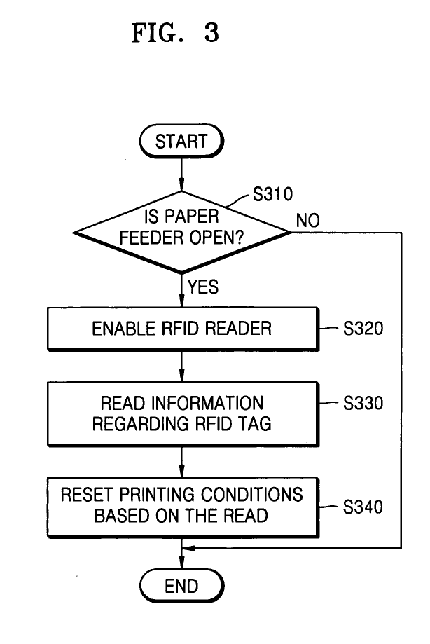

A method of optimizing printing conditions of an image forming apparatus will now be described with reference to FIG. 3. Referring to FIG. 3, first, whether a paper feeder of the image forming apparatus is open is monitored (S310). A sensor installed in the image forming apparatus may be used to determine whether the paper feeder is open.

If it is determined in operation S310 that the paper feeder is open, an RFID reader of the image forming apparatus operates to read information from an RFID tag attached to packing paper of printing paper or a box containing a bundle of sheets of paper (S320 and S330). In this case, a user must move the packing paper or the box attached with the RFID tag within the operating distance of the RFID reader.

The information stored in the RFID tag includes paper identification information specifying the size, thickness, and type of the printing paper. Of course, the paper identification information may further indicate a manufacturing company and the date of manufacture.

Next, information regarding the printing paper included in the information read from the RFID tag in operation S330 is parsed, and the printing conditions are optimized (S340). Here, printing condition factors include a transfer voltage, fixing temperature, the speed of reaction, and so on. For instance, it is possible to determine optimal printing conditions corresponding to the characterization factors of the printing paper, specified in the paper identification information, using a lookup table.

As described above, according to an embodiment of the present invention, various characterization information regarding printing paper is acquired using the RFID technology and printing conditions are optimized according to the various characterization information. Therefore, embodiments of the present invention are advantageous in that (i) the size of paper is automatically sensed, thus removing a need for manually selecting the size of paper for a print job, (ii) image forming conditions are optimized according to the characteristics of paper, thereby improving the quality of printing, and (iii) the size of paper can be sensed without additionally installing a sensor therefor.

Embodiments of the present invention may be embodied as a method, an apparatus, or a system. When embodiments of the present invention are realized as software, the members of the present invention are code segments required to perform necessary operations. Programs or code segments may be stored in a processor readable medium or be transmitted by a transmission medium or by a computer data signal combined with a carrier in a communication network. The processor readable medium may be any medium, such as an electronic circuit, a semiconductor memory device, a ROM, a flash memory, EEPROM, a floppy disc, an optical disc, a hard disc, an optical fiber medium, a radio frequency (RF) network, or any other suitable medium which can store or transmit information. The computer data signal may be any signal which can be transmitted through a transmission medium such as an electronic network channel, an optical fiber, air, an electromagnetic field, or an RF network.

While this invention has been particularly shown and described with reference to exemplary embodiments thereof, it will be understood by those skilled in the art that various changes in form and details may be made therein without departing from the spirit and scope of the invention as defined by the appended claims.

1. A method of determining printing conditions of an image forming apparatus, comprising:
sensing whether a paper feeder is open;
reading paper identification information from a radio frequency identification tag when the paper feeder is open; and
determining optimal image forming conditions based on the read identification information.

2. The method of claim 1, wherein the radio frequency identification tag is attached to packing paper of a bundle of predetermined sheets of paper.

3. The method of claim 1, wherein the radio frequency identification tag is attached to a packing box of plural bundles of predetermined sheets of paper.

4. The method of claim 1, wherein the radio frequency identification tag comprises a passive tag which does not include a battery.

5. The method of claim 1, wherein the paper identification information specifies the size, thickness, and type of the paper.

6. The method of claim 1, wherein the image forming conditions comprise a transfer voltage, fixing temperature, and the speed of reaction.

7. The method of claim 1, wherein the optimal image forming conditions are determined using a lookup table listing printing condition factors which are experimentally measured using corresponding factors included in the paper identification information, the printing condition factors being the optimal image forming conditions.

8. An apparatus for determining printing conditions of an image forming apparatus, comprising:
a radio frequency identification tag including paper information;
a radio frequency identification reader for reading information from the radio frequency identification tag;
a paper feeder opening/closing detection sensor for sensing whether a paper feeder is open or closed; and
a controller for enabling the radio frequency identification reader only upon a receipt of status information indicating that the paper feeder is open from the paper feeder opening/closing detection sensor, parsing paper identification information read by the radio frequency identification reader, and determining optimal image forming conditions.

9. The apparatus of claim 8, wherein the radio frequency identification tag is attached to packing paper of a bundle of predetermined sheets of paper.

10. The apparatus of claim 8, wherein the radio frequency identification tag is attached to a packing box of plural bundles of predetermined sheets of paper.

11. The apparatus of claim 8, wherein the radio frequency identification tag comprises a passive tag which does not include a battery.

12. The apparatus of claim 8, wherein the paper identification information specifies the size, thickness, and type of the paper.

13. The apparatus of claim 8, wherein the image forming conditions comprise a transfer voltage, fixing temperature, and the speed of reaction.

14. The apparatus of claim 8, wherein the optimal image forming conditions are determined using a lookup table listing printing condition factors which are experimentally measured using corresponding factors included in the identification information, the printing condition factors being the optimal image forming conditions.

15. A computer readable medium of instructions for controlling an apparatus to determine printing conditions of an image forming apparatus, comprising:
a first set of instructions adapted to control the apparatus to sense whether a paper feeder is open;
a second set of instructions adapted to read paper identification information from a radio frequency tag when the paper feeder is open; and
a third set of instructions adapted to control the apparatus to determine optimal image forming conditions based on the read identification information.

16. The computer readable medium of instructions of claim 15, where the paper identification information specifies the size, thickness, and type of the paper.

17. The computer readable medium of instructions of claim 15, wherein the image forming conditions comprise a transfer voltage, fixing temperature, and the speed of reaction.

18. The method of claim 1, wherein the reading of the paper identification information from the radio frequency identification tag comprises:
transmitting a tag information request signal from a radio frequency identification reader to the radio frequency identification tag when the paper feeder is open;
reading tag information including the paper identification information stored in a memory of the radio frequency identification tag according to the transmitted tag information request signal; and
transmitting the tag information read from the memory of the radio frequency identification tag to the radio frequency identification reader.

19. The method of claim 18, wherein the tag information request signal if modulated by the radio frequency identification reader and radiated through an antenna.

20. The method of claim 18, wherein the radio frequency identification tag receives the tag information request signal radiated by the radio frequency identification reader through a coil antenna and generates supply power of the radio frequency identification tag using an electromotive force induced to the coil antenna.
